(19) United States
(12) Patent Application Publication
(10) Pub. No.: US 2014/0081670 A1
(43) Pub. Date: Mar. 20, 2014

(54) SYSTEM AND METHOD FOR AUTOMATED VALIDATION AND AUGMENTATION OF QUOTATION DATA

(71) Applicants: Ben J. Lim, South Windsor, CT (US); Christopher P. DiMartino, Southington, CT (US)

(72) Inventors: Ben J. Lim, South Windsor, CT (US); Christopher P. DiMartino, Southington, CT (US)

(73) Assignee: HARTFORD FIRE INSURANCE COMPANY, Hartford, CT (US)

(21) Appl. No.: 13/616,083

(22) Filed: Sep. 14, 2012

(51) Int. Cl. G06Q 40/08

(52) U.S. Cl. 705/4

(57) ABSTRACT

A commercial insurance policy quoting system for administering and managing commercial insurance policies is disclosed. The commercial insurance policy quoting system has automatic validation and intelligent pre-fill capabilities to ease the commercial quoting process for agents and consumers. Location based information and social network information may also be used to verify and augment submitted insurance information.

### BACKGROUND

A commercial or business automobile insurance policy provides protection for business owners and the vehicles that a business may use during the course of conducting their respective commercial enterprises. The commercial automobile policy protects the vehicles that are owned, leased, hired or rented for the business. This type of insurance is critical to protect the business when an employee or customer gets injured such as when an employee or someone affiliated with the business causes an accident while driving a vehicle owned or used by the business.

Collision coverage helps to protect the business from financial loss if a vehicle owned or rented by the business is damaged in an accident. Comprehensive coverage provides insurance for the business when damage to the vehicles is caused by a variety of risks including fire, lightning, theft, hail and flood.

Such coverages are essential to businesses for their every day survival. However, the conventional quotation processes and systems for obtaining such coverages is severely antiquated and many times very manual and cumbersome. Insurance agents these days have to manually key in the bulk of business data such as the business name, address, driver names, driver addresses, Vehicle Identification Number (VIN) and then manually access motor vehicle reports data and other pieces of information essential to the quoting process.

These manual processes are extremely time consuming and prone to user error. Accordingly, it would be desirable to have a system that could provide an expedited and automated quotation process for agents as well as the corresponding business customers.

### SUMMARY

In one embodiment, the present invention is a commercial automobile insurance quoting system, comprising: a data storage device storing data associated with a commercial automobile information database; a computer processor for executing program instructions and configured to retrieve the data associated with the commercial automobile information database from the data storage device; and a memory, coupled to the computer processor, storing program instructions for execution by the computer processor to: receive, from a remote entity, complete or partial commercial business data submitted via an electronic quoting system in connection with business and driver data associated with a commercial entity; automatically validate the submitted commercial business data based at least in part on information accessed from at least two or more of a municipal data source, a commercial information service, a social network and a location based data source; iteratively augmenting the validated insurance data from at least two of the municipal data source, commercial information service, the social network and the location based data source to automatically compile sufficient insurance data to determine a commercial automobile insurance quotation for the commercial entity; determine a bindable commercial automobile insurance quotation for the commercial entity based on the validated and augmented data; and transmit the commercial automobile insurance quotation for display in the electronic quoting system.

In other embodiments, the present invention is a computer-implemented method associated with a commercial automobile insurance quoting process, comprising: receiving, from a remote entity, commercial insurance data submitted via an online quoting system; automatically verifying, by a processor, the submitted commercial insurance data based at least in part on information stored in a third party database and at least one third party website; supplementing the submitted commercial insurance data from one or more third party data sources; and issuing commercial insurance quotation data based on the verified and supplemented commercial insurance data.

The present invention in other embodiments is a non-transitory computer-readable medium storing instructions adapted to be executed by a computer processor to perform a commercial insurance based method, said method comprising: receiving, from a remote insurance submitter, insurance data submitted via a web based quoting sub-system; validating the submitted insurance data based at least in part on social network information and geo-location information; and iteratively augmenting the submitted insurance data with third party information from at least one remote information provider to automatically compile sufficient information without requiring further input from the remote insurance submitter; calculating a commercial insurance premium quotation based on the validated and augmented information; and formatting for display the commercial insurance premium quotation for a portable computing device.

### BRIEF DESCRIPTION OF THE DRAWINGS

A more detailed understanding may be had from the following description, given by way of example in conjunction with the accompanying drawings wherein:

FIG. 1 shows an exemplary computer architecture that may be used for insurance quote administration and management;

FIG. 2 shows an exemplary system that may be used for the management of insurance quotations;

FIGS. 3a-e shows an exemplary system screens of the present invention;

FIG. 4 shows an exemplary system device in operation;

FIG. 5 shows an exemplary method of the present invention;

FIG. 6 shows another exemplary method of the present invention; and

FIG. 7 shows another exemplary device of the present invention.

### DETAILED DESCRIPTION

Disclosed herein are processor-executable methods, computing systems, and related technologies for the quoting, management and communication of commercial automobile insurance coverages. Utilizing the present invention, an insurance agent or business consumer can quickly and efficiently obtain accurate premium quotations for a variety of businesses and coverages such as for business or commercial automobile insurance. For example, exemplary business automobile coverages may include Bodily Injury and Property Damage liability, Physical Damage (Collision), Physical Damage (Comprehensive), Hired Auto Physical Damage, Hired Auto and Non-Owned Auto, Uninsured/Underinsured Motorist, Medical Payments, Autos Rented by Employees, Electronic Equipment Coverage, Glass Repair, Lease & Loan Gap Coverage, Temporary Transportation Expense, Airbag Coverage, and Hybrid Payment Coverages. The present invention can automatically validate a basic amount of information provided by an agent or business consumer and augment or supplement such information to provide a bindable quotation for commercial automobile insurance in an expedited manner. Utilizing the present invention, agents or business consumers only have to provide a minimum amount of information about the businesses in order to obtain a quotation without having to manually enter in much of the information which now may be automatically obtained through use of the present invention.

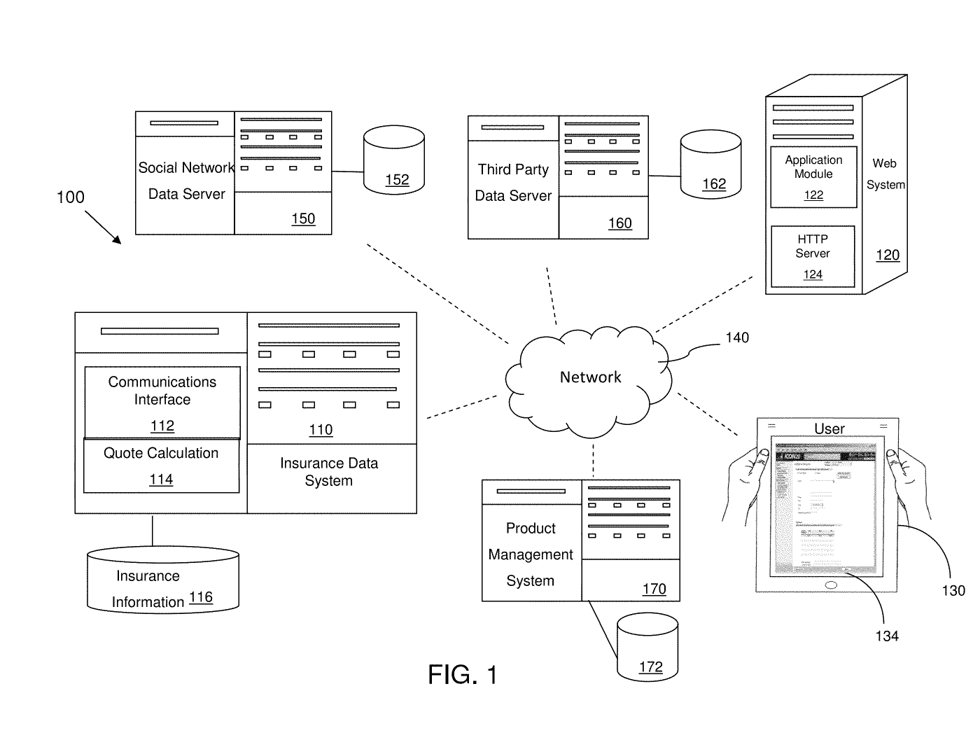

FIG. 1 shows an example system architecture 100 that may be used for the administration and management of commercial insurance quotations including commercial automobile insurance quotations. The example system architecture 100 may include a commercial insurance data system 110, a web site system 120, a user device 130, a network 140, a social network data server system 150, at least one third party data server system 160 and a product management system 170. In the example architecture 100 of FIG. 1, the commercial insurance data system 110 and the product management system 170 may be under the control of an insurance/financial services company and their associated agents/brokers. User device 130 may be operated by a captive, affiliated or independent agent or directly by a business consumer. In other embodiments, commercial insurance data system 110 may be integrated with product management system 170 with both commercial insurance data system 110 and product management system 170 being under the control of an insurance entity or a party authorized by the insurance entity.

Referring still to FIG. 1, commercial insurance data system 110 may include a communications interface module 112, an insurance quote calculation module 114, and an insurance information database 116. The insurance quote calculation module 114 may include one or more software modules or objects and one or more specific-purpose processor elements to perform the calculations and processing required by the present invention such as for calculating the premium for a commercial automobile insurance policy. In some embodiments, the insurance quote calculation module 114 may also include one or more business rules and one or more predictive models. The business rules may provide guidelines on how to rate and quote requested coverage for commercial entities based on insurance product coverage variations, state and other regulatory rules and constraints and insurance entity policies and procedures. Rules relating to how much information is needed before a quotation may be obtained and rules relating to state specific requirements for information access may also be included. Other business rules may be implemented in accordance with the present invention.

In operation, the insurance quote calculation module 114 may receive client data in a commercial insurance context such as drivers license number, make and model of vehicle, mileage, approximate annual use of the vehicle, how many authorized drivers and ages of each, general driving history, VIN number for vehicle to be insured, a list of the vehicle's safety and anti-theft devices, policy numbers of existing polices (for multi-policy discounts/only applies to current insurer), address of drivers and business, etc. provided through client device 130 of the present invention. The received client data may be basic driver and vehicle information. For example, basic driver information may include driver name, address, and present driver's license state and commercial or non-commercial driver's license number. Insurance quote calculation module 114 also receives or accesses certain third party data, such as data of municipal and other local government and quasi-governmental agencies, motor vehicle department data, social network information, as well as other third party sources of information such as through social network data server 150 and third party data server 160. Using the accessed third party data, insurance quote calculation module 114 validates and augments the received client data.

Insurance quote calculation module 114 in conjunction with product management system 170 may also output one or more quotations for one or more commercial insurance services products such as commercial automobile insurance for review and approval by the user. Insurance quote calculation module 114 may also determine the premium based on the basic information provided by the user and the validation and augmentation of the user information by the system. As used herein, validation may include determining that certain data or information meets certain pre-determined specifications and quality attributes as well as satisfying defined formats and other criteria. For example, validation may include selecting from a list of similar business names to determine that the current business name is correct. Validation may also include matching a business name with a location or matching a business owner with a vehicle or Motor Vehicle Record (MVR). For example, in another scenario, the user would be an insurance agent who would input an owner's name and a commercial entity name into the system and the names would then be validated and augmented with additional information such as address, additional drivers, MVR, driver information, Vehicle Identification Number (VIN), Driver's License Number, etc. In an embodiment, the client data may include basic driver data, such as name, address, state and license number and age, and the augmentation of the basic driver data may add licensing history and violation history for the driver.

Insurance quote calculation module 114 may determine premium allocations in any suitable manner. By way of example, insurance quote calculation module 114 may access one or more databases containing one or more tables having determined dollar figures, or formulas or combinations thereof, for a premium based on factors including type of coverage (e.g., automotive, homeowners, renters or other type of coverage), jurisdiction (e.g., state) of coverage, covered property address, coverage limits, type of covered vehicle for automotive policies (e.g., ranges of vehicle weights and types of trucks, makes and models of cars, ages of vehicles), type of roads on which vehicle is to be predominantly driven (e.g., limited access, arterial, urban commercial, urban residential) type of use of vehicles (e.g., long-haul freight transport, delivery of meals to residential addresses, for example), typical periodic (e.g. annual) mileage driven, policy term, driving records of authorized drivers, and other data. Any combination of dollar values and formulas may also be employed in the determination of premium allocations.

The insurance information database 116 may store information such as the user provided input, premium information, social network information, and third party data information related to the user/applicant. Insurance information database 116 may be spread across one or more computer-readable storage media, and may be or include one or more relational databases, hierarchical databases, object-oriented databases, one or more flat files, one or more spreadsheets, and/or one or more structured files. Insurance information database 116 may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology.

Communication between the commercial insurance data system 110 and the other elements in the example architecture 100 of FIG. 1 may be performed via the communications interface module 112 interacting with network 140. The commercial insurance data system 110 may also access third party systems and third party data, not shown, which may include motor vehicle department data, driving history, social network history and activity and other sources of information which may impact the insurance determinations and transactions herein via network 140. For example, commercial insurance data system 110 may interface with computer systems associated with one or more third party sites to receive data related to client 130 such as the applicant's business characteristics, risk profiles, etc. For example, third party sites may include e-commerce sites, utility provider sites, automobile sites, business sites and other variety of sites accessible via the Internet.

Referring still to FIG. 1, the product management system 170 may perform functionality such as storing and processing information related to certain insurance products such as automobile insurance and commercial/business insurance. For example, the product management system 170 may include information on certain types of insurance products such as the product characteristics, benefits, features, deductibles, limits, etc. The product management system 170 may store this information in a product management database 172. The product management database 172 may also be spread across one or more computer-readable storage media, and may be or include one or more relational databases, hierarchical databases, object-oriented databases, one or more flat files, one or more spreadsheets, and/or one or more structured files. As will be described in further detail below, the commercial insurance data system 110 may use information from the product management database 172 to select and purchase or sell potential products which may be suitable for one or more clients based on their information and needs.

Referring still to FIG. 1, a web site system 120 may provide a web site that may be accessed directly by a consumer operating a user client device 130. User client device 130 can include, but is not limited to cellular telephones, other wireless communication devices, personal digital assistants, pagers, laptop computers, tablet computers, smartphones, or combinations thereof. The user client device may store data including application or app data, and the processor of the user client device or a processor of web site system 120 or another system may be configured to render a graphical user interface as described herein via the mobile device app. In the present invention, user client device 130 may communicate with the web site system 120 that may be operated by or under the control of an insurance entity or other third party entity such as an outsourced type entity or third party administrator type entity. The web site system 120 may generate one or more web pages for access by client device 130, and may receive responsive information from the client device 130 such as user information for obtaining an insurance quotation for a commercial automobile type product. The responsive information may include information that identifies the business consumer, information related to the product(s) that the business consumer is viewing, purchasing or requesting, and/or other related types of information. The web site system 120 may then communicate this information to the insurance management system 110 for processing via communications interface module 112. The web site system 120 may also communicate one or more web pages to the client device 130 that provide one or more product options that may be suitable for the consumer from product management system 170.

In operation, client device 130 may be used to input information, approve and/or select one or more of the product options, such as commercial insurance options. Selection via client device 130 may be accomplished via a touch-sensitive touch screen that provides an input interface and an output interface between the client device 130 and the client or user. The client device 130 displays visual output to the user for manipulation by the user. The visual output may include checkboxes, radio buttons, graphics, text, icons, video, and any combination thereof. The visual output may include a commercial automobile option selection screen in a graphical user interface, by way of example. The touch screen may display one or more graphics within user interface displayed on device 130. In this embodiment, as well as others, a user may select one or more of the graphical elements by making contact or touching the graphics, for example, with one or more fingers or stylus implements or other input type devices.

Referring still to FIG. 1, the web site system 120 may include an insurance web application module 122 and a HyperText Transfer Protocol (HTTP) server module 124. The web application module 122 may generate the web pages that make up the web site and that are communicated by the HTTP server module 124. The insurance web application module 122 may be implemented in and/or based on a technology such as Active Server Pages (ASP), PHP: Hypertext Preprocessor (PHP), Python/Zope, Ruby, any server-side scripting language, and/or any other appropriate technology.

The HTTP server module 124 may implement the HTTP protocol, and may communicate HyperText Markup Language (HTML) pages and related data from the web site to/from the client device 130 using HTTP. The HTTP server module 124 may be, for example, a Sun-ONE Web Server, an Apache HTTP server, a Microsoft Internet Information Services (IIS) server, and/or may be based on any other appropriate HTTP server technology. The web site system 120 may also include one or more additional components or modules (not depicted), such as one or more switches, load balancers, firewall devices, routers, and devices that handle power backup and data redundancy.

Referring still to FIG. 1, the client device 130 may include a web browser module 134, which may communicate data related to the web site to/from the HTTP server module 124 and the insurance web application module 122 in the web site system 120. The web browser module 134 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 134 may implement Rich Internet Application (RIA) and/or multimedia technologies such as Adobe Flash, Microsoft Silverlight, and/or other technologies. The web browser module 134 may implement RIA and/or multimedia technologies using one or more web browser plug-in modules (such as, for example, an Adobe Flash or Microsoft Silverlight plugin), and/or using one or more sub-modules within the web browser module 134 itself. The web browser module 134 may display data on one or more displays that are included in or connected to the client device 130, such as a liquid crystal display (LCD) display, organic light-emitting diode (OLED) display, touch screen or monitor. The client device 130 may receive input from the user of the client device 130 from input devices (not depicted) that are included in or connected to the client device 130, such as a mouse or other pointing device, or a touch screen, and provide data that indicates the input to the web browser module 134.

The example architecture 100 of FIG. 1 may also include one or more wired and/or wireless networks within network 140 via which communications between the elements 110, 120, 130, 150, 160 and 170 in the example architecture 100 may take place. The networks may be private or public networks, and/or may include the Internet. In one example deployment scenario, the commercial insurance data system 110, web site system 120, social network data server system 150 and product management system 170 may communicate via one or more private networks that are under the control of the financial services/insurance company, while the client device 130 may communicate with the web site system 120 via the Internet.

Each or any combination of the modules 112, 114, 122, and 124 shown in FIG. 1 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules 112, 114, 122, and 124 may perform functionality described later herein.

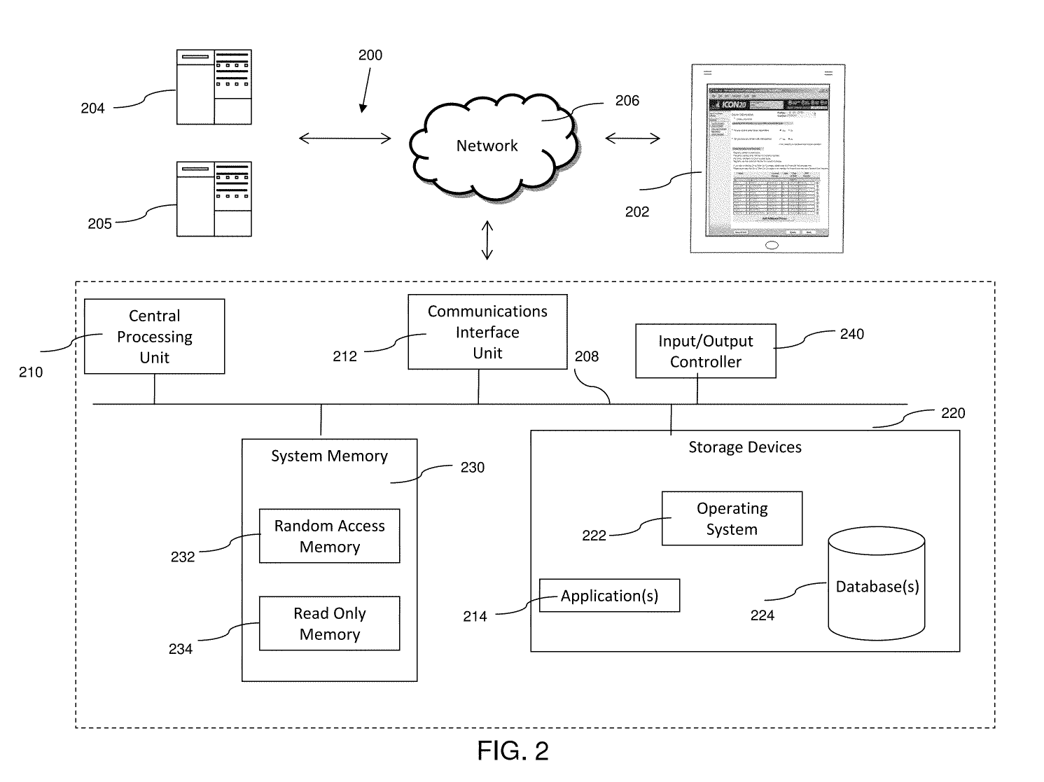

Referring to FIG. 2, an exemplary computer system 200 for use in an implementation of the invention will now be described. Computer system 200 may be configured to perform commercial insurance quotation processing and management for one or more commercial related users, clients or customers 202. System 200 may interface with third party data sources 204 and 205 via a network 206. Third party data sources 204 and 205 may be any one of a commercial information service provider, a data aggregator, a social network, a municipality or other information entity. In computer system 200, a central processing unit or processor 210 executes instructions contained in programs such as commercial automobile insurance quotation application program 214, stored in storage devices 220. Processor 210 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 220 may include suitable media, such as optical or magnetic disks, fixed disks with magnetic storage (hard drives), tapes accessed by tape drives, and other storage media. Processor 210 communicates, such as through bus 208 and/or other data channels, with communications interface unit 212, storage devices 220, system memory 230, and input/output controller 240. System memory 230 may further include a random access memory 232 and a read only memory 234. Random access memory 232 may store instructions in the form of computer code provided by application 214 to implement the present invention. System 200 further includes an input/output controller 240 that may communicate with processor 210 to receive data from user inputs such as pointing devices, touch screens, and audio inputs, and may provide data to outputs, such as data to video drivers for formatting on displays, and data to audio devices.

Storage devices 220 are configured to exchange data with processor 210, and may store programs containing processor-executable instructions, and values of variables for use by such programs. Processor 210 is configured to access data from storage devices 220, which may include connecting to storage devices 220 and obtaining data or reading data from the storage devices, or placing data into the storage devices. Storage devices 220 may include local and network accessible mass storage devices. Storage devices 220 may include media for storing operating system 222 and mass storage devices such as storage 224 for storing data related to insurance information related to the customers such as driving history, etc. Communications interface unit 212 may communicate via network 206 with other third party servers 204 and 205 as well as other servers, computer systems of agents, customers, remote sources of data, and with systems for implementing instructions output by processor 210. Servers 204 and 205 may also be configured in a distributed architecture, wherein databases and processors are housed in separate units or locations. Some such servers perform primary processing functions and contain at a minimum, a RAM (random access memory), a ROM (read-only memory), and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. Network 206 may be or include wired or wireless local area networks and wide area networks, and over communications between networks, including over the Internet. One or more public cloud, private cloud, hybrid cloud and cloud-like networks may also be implemented, for example, to handle and conduct processing of one or more transactions or calculations of the present invention, including computation of a commercial automobile quotation premium for transmission to a user/application. Cloud based computing may be used herein to handle any one or more of the application, storage and connectivity requirements of the present invention. Furthermore, any suitable data and communication protocols may be employed to accomplish the teachings of the present invention.

With reference still to FIG. 2, communications interface unit 212 is used for receiving user data related to the user's insurance requirement and background. Computer processor 210 executes program instructions, such as provided by application 214 to receive, via the communications interface 212, third party data, social network data and other related information. Database 224 may include transaction data such as historical data from the user or other third parties.

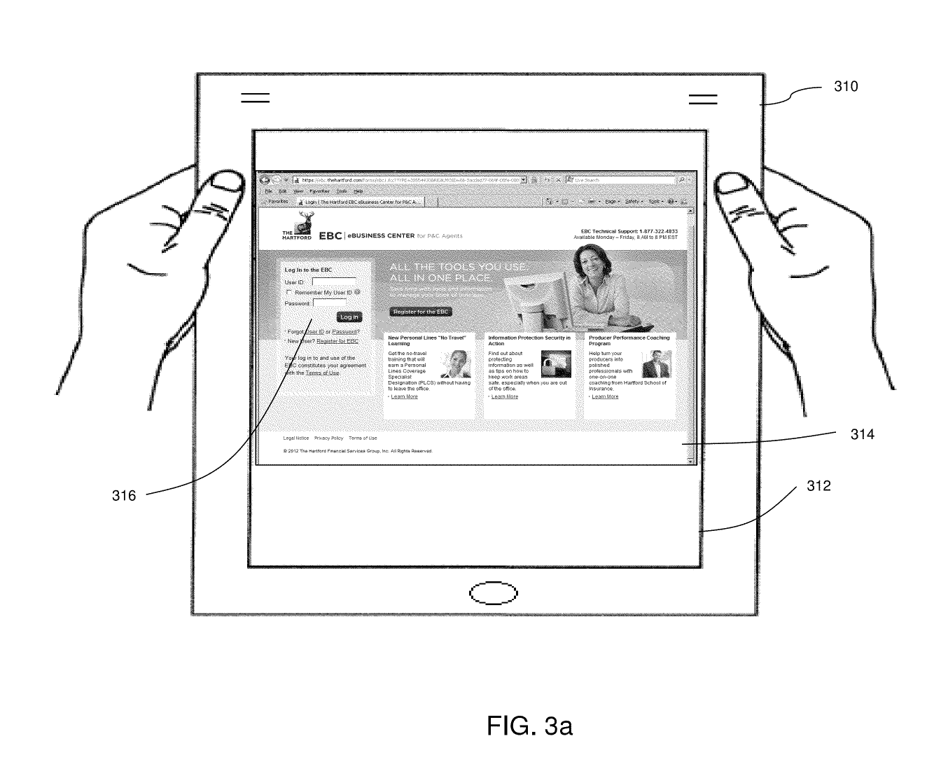

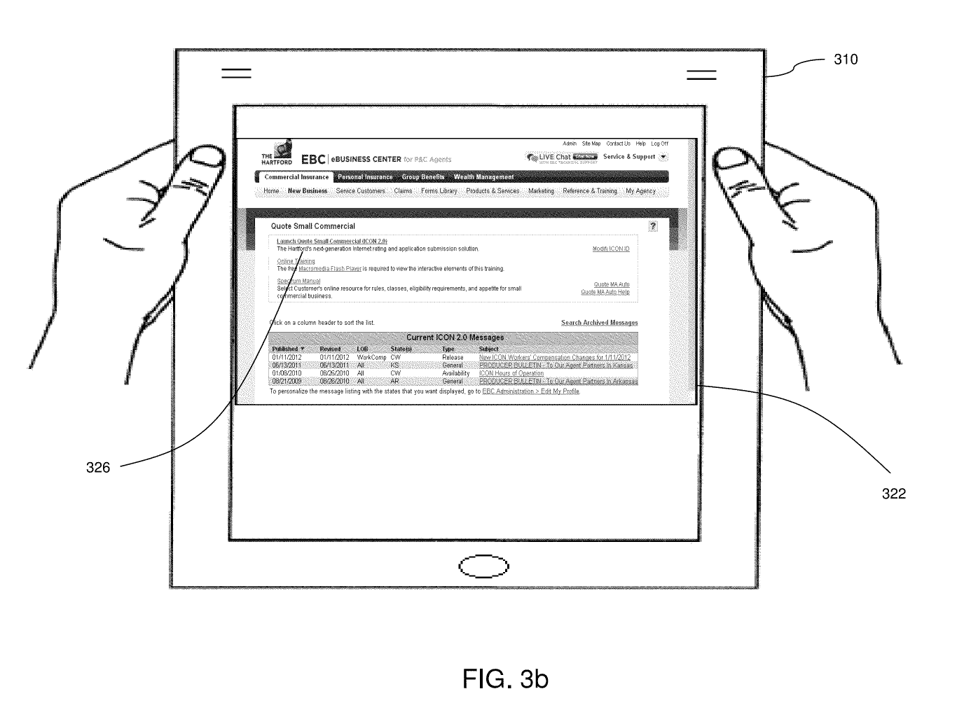

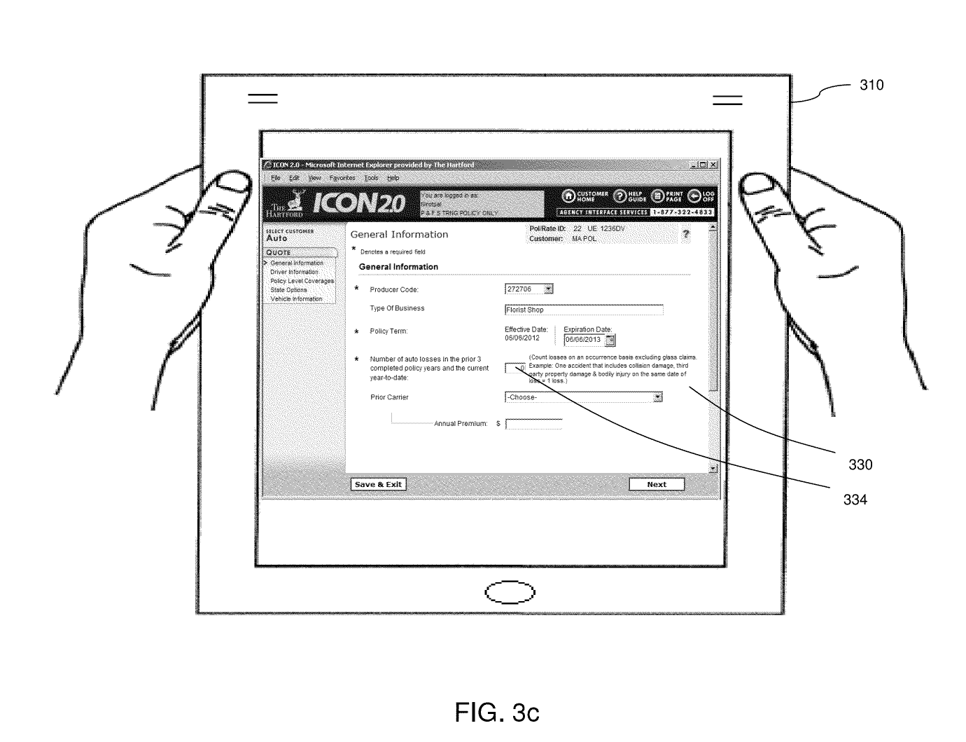

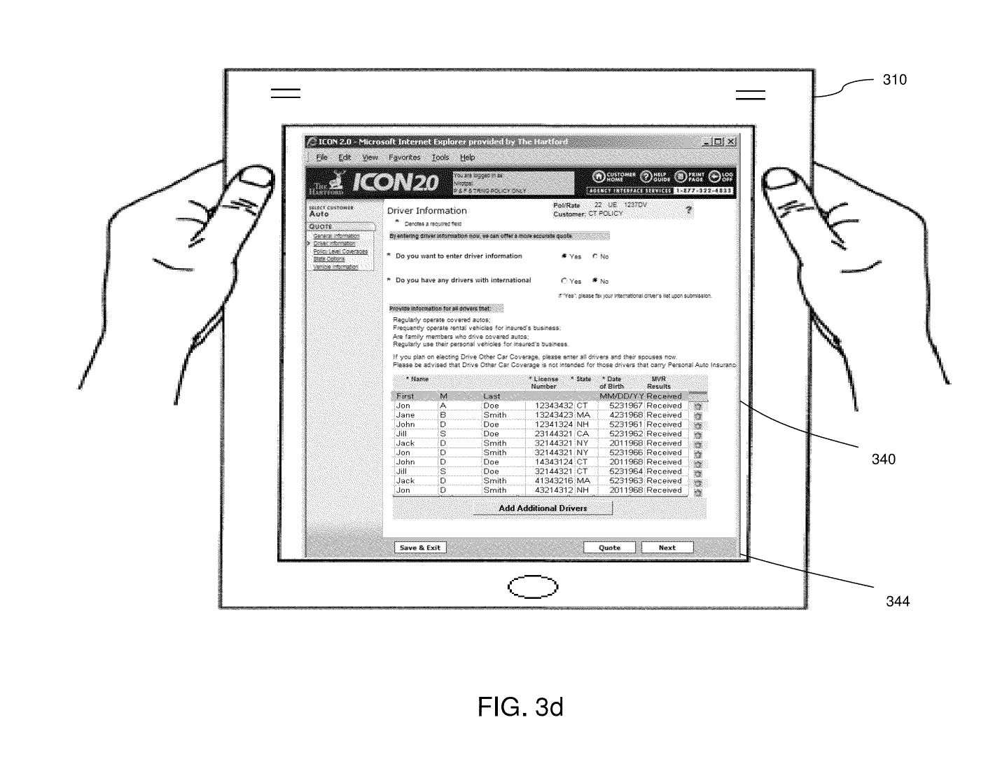

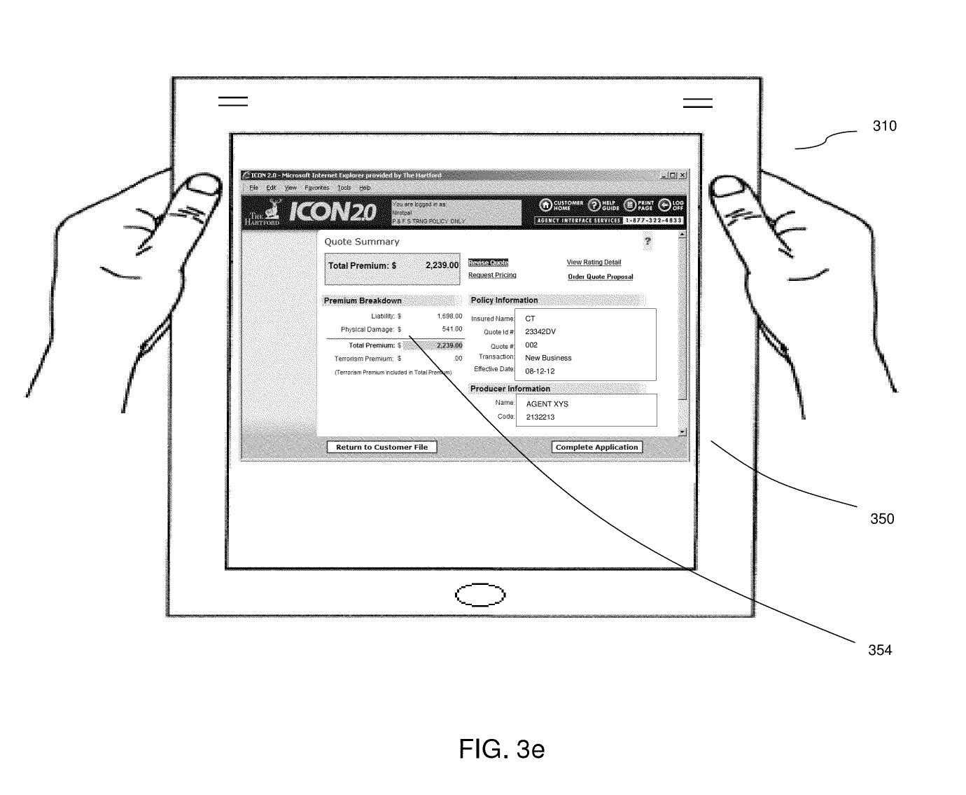

FIG. 3a illustrates an exemplary screen of the present invention as may be displayed among user/client devices shown in FIGS. 1 and 2. In one embodiment, a user such as a commercial insurance agent or a commercial business owner operates a device 310, such as a portable computing device for viewing and accessing information and data related to an commercial insurance policy as described herein. Portable computing device 310 may include a touch screen 312 that can be an active sensor employing capacitive, resistive, inductive, or other methods, or it can be a passive surface on which touch sensing is accomplished by optical, acoustic, or other similar methods. Device 310 can also be a liquid crystal display (LCD), organic light emitting diode (OLED) display, electroluminescent display, or any other type of small display suitable for mounting in a portable computer or mobile device. Device 310 may be color or monochrome, and may include a backlight capability to enhance readability in various lighting conditions.

In the present invention, device 310 displays a web document 314 for access by a user. Web document 314 may include an input area 316 for logging into a commercial insurance portal or web page for commercial insurance quotations. Web document 314 displays information related to insurance products, tools and programs for use by an agent or business consumer.

FIG. 3b illustrates another exemplary screen of the present invention as may be displayed among user/client devices shown in FIGS. 1 and 2. In one embodiment, a user such as a commercial insurance agent or a commercial business owner operating device 310 logs into insurance portal shown in FIG. 3a to access commercial insurance web page 322 for providing and managing commercial insurance quotations. Web page 322 may include one or more hyperlinks or sublinks 326 for accessing a quotation subpage or site, training or other related information.

FIG. 3c illustrates yet another exemplary screen of the present invention as may be displayed among user/client devices shown in FIGS. 1 and 2. In one embodiment, the commercial insurance agent or a commercial business owner operating device 310 accesses screen 330 for inputting preliminary information about a business or commercial enterprise in order to obtain a commercial automobile insurance quotation. Preliminary information may include all or a portion of one or more of the following including business name, address, business owner, type of business, location, Driver's License Number, Vehicle Identification Number, etc. The Driver's License Number may be for one or more drivers associated with the business. If the Driver's License Number information, and/or other driver information, includes information relating to more than one driver, those drivers may be unrelated drivers, i.e., not related to one another. In other embodiments, one or more drivers may be related, such as multiple family members who are authorized drivers for a family-owned business. Information within screen 330 may be input in a variety of manners such as a text input area 334, dialog box, pull down menu or other similar input mechanisms.

FIG. 3d illustrates yet another exemplary screen of the present invention as may be displayed among user/client devices shown in FIGS. 1 and 2. In one embodiment, the commercial insurance agent or a commercial business owner operating device 310 accesses screen 330 for inputting preliminary information about a business or commercial enterprise in order to obtain a commercial automobile insurance quotation. Information within screen 340 may be input in a variety of manners such as a text input area 344, dialog box, pull down menu or other similar input mechanisms. Information such as First Name, Middle Initial or Middle Name, Last Name, State, Date of Birth, Drivers License # (usually 9-10 digits, can be letters or numbers), business name, etc. may be provided by the agent or owner in screen 330. In the present invention, input of some of the foregoing preliminary information triggers the automatic retrieval and validation of the related business information. For example, the user may enter simply a business name and through a combination of global positioning system (GPS), social network, state department of motor vehicles (DMV) and third party data aggregator information, the system would compile enough information to produce a commercial insurance quote simply from the entry of the business name without requiring additional manual entry from the agent or business owner.

FIG. 3e illustrates yet another exemplary screen of the present invention as may be displayed among user/client devices shown in FIGS. 1 and 2. In one embodiment, the commercial insurance agent or a commercial business owner operating device 310 accesses screen 350 for receiving quotation related to commercial automobile insurance. Screen 350 includes quotation information 354 specific to the business or commercial enterprise and may be a bindable quotation. A bindable quotation requires the insurance company to issue a policy at the stated premium amount and terms upon acceptance by the commercial business owner or representative. Conditions placed upon acceptance may include tendering premium payment. Upon acceptance of the quotation shown in screen 350, the user may be provided an electronic insurance identification card via another web page, email or text message. In some embodiments, a nonbinding premium indication may be provided on device 310. The text and graphics on device 310 may provide instructions for additional information or documents to be provided by the business owner to the insurance company in order for a bindable quotation to be determined and communicated.

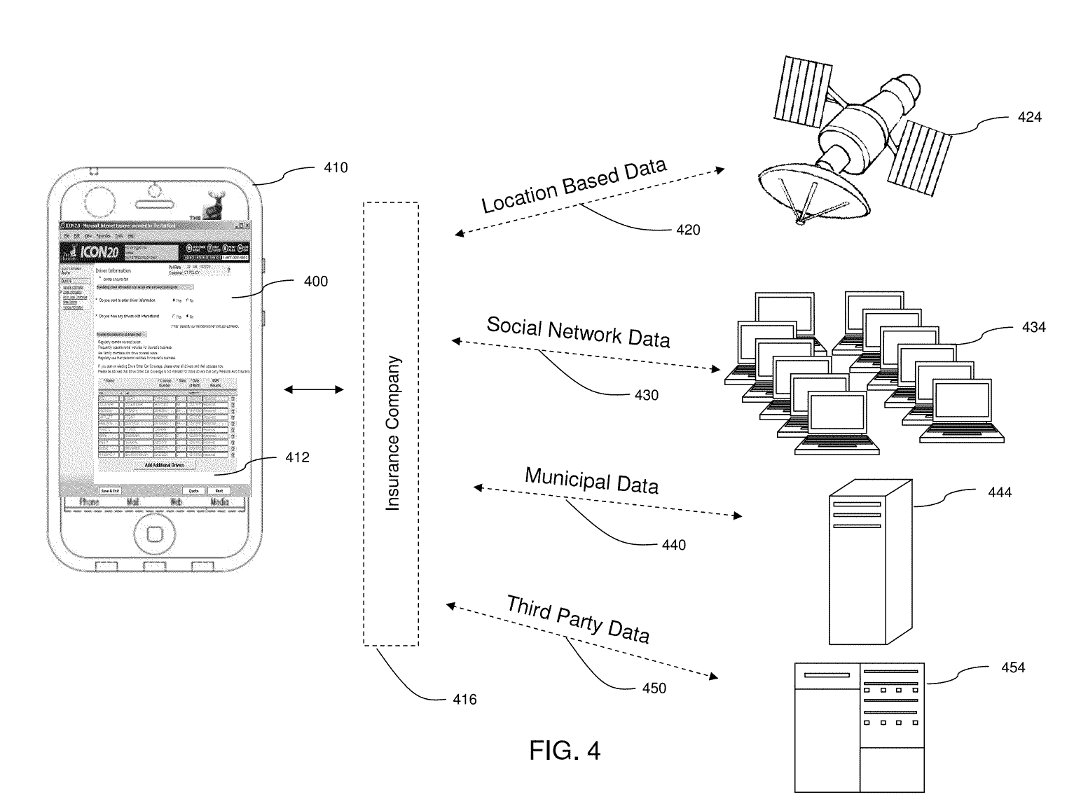

Referring to FIG. 4, in some embodiments, the present invention may be implemented on various mobile device applications 400 that a user or participant can download into a mobile device 410 for allowing users or participants to get and view commercial insurance quotations. As shown, the mobile device 410 can launch (and operate under the control of) one or more application programs by selecting an icon associated with an application program. Those skilled in the art will recognize that mobile device 410 may have a number of additional different icons and applications, and that applications may be launched in other manners as well. In the embodiment shown, an application, such as a commercial insurance application 400, is launched by the user tapping or touching an icon displayed on the touch screen 412 interface of the mobile device 410. Touch screen 412 may accept input regarding the business to be quoted and also provide information related to coverages and quotation premiums.

Once commercial insurance application 400 is launched, the user may interact with commercial insurance application 400, and mobile device 410 may function pursuant to the program instructions associated with the application. During operation, mobile device 410 interfaces with an insurance company entity 416 that is in communication with remote systems. Via insurance company entity 416, mobile device 410 may, for example, exchange location based data 420 with a location based network or server 424, social network information 430 with a social network 434, municipal data 440 with a municipal server 444 and third party data 450 with a third party information aggregator 454. In operation, mobile device 410 would have access via an insurance company entity 416 to the location based data 420, social network information 430, municipal data 440 and third party data 450 to validate and augment the commercial insurance quotation information. Mobile device 410 may have access directly to location data, such as via GPS capability implemented in mobile device 410, and may provide location data to application 400. For example, upon inputting a business name via mobile device 410, application 400 may provide location data obtained by device 410, and the location of the business may be validated, and/or disambiguation between businesses of the same or similar names in different locations may be performed, via location based network 424 while other validation and augmentation may be performed via accessing social network 424 such as validating the business name and type and/or augmenting the business members or additional drivers for the commercial entity. Accessing social network 424 may include accessing a professional networking website or professional networking service to obtain additional data relating to the business and members, executives, employees and other individuals related to the business. Additionally, driver's license numbers, motor vehicles records, and Vehicle Identification Number may be accessed via municipal server 444 and third party information aggregator 454. In other embodiments, the system may intelligently pre-fill portions or gaps in data to proceed with the commercial insurance quotation. For example, the user may enter in via mobile device 410, the first three digits or letters of a driver's license number and a partial business name and the system would perform validation, matching and prefill of that incomplete data to complete the data points and proceed with the quotation. In another example, the user may simply enter a business owner name and the system iteratively validates and augments this data such as by using the location based information 420 for the mobile device 410 to validate the business owner name with a business name. The system would then validate the business name with one or more drivers and/or vehicles associated with the business name, such as may be available via social network 424, municipal server 444 and/or third party information aggregator 454. Vehicle identification numbers and motor vehicle driving reports associated with each driver/vehicle would then be accessed via municipal server 444 and/or third party information aggregator 454 to compile sufficient information to produce a commercial vehicle quote.

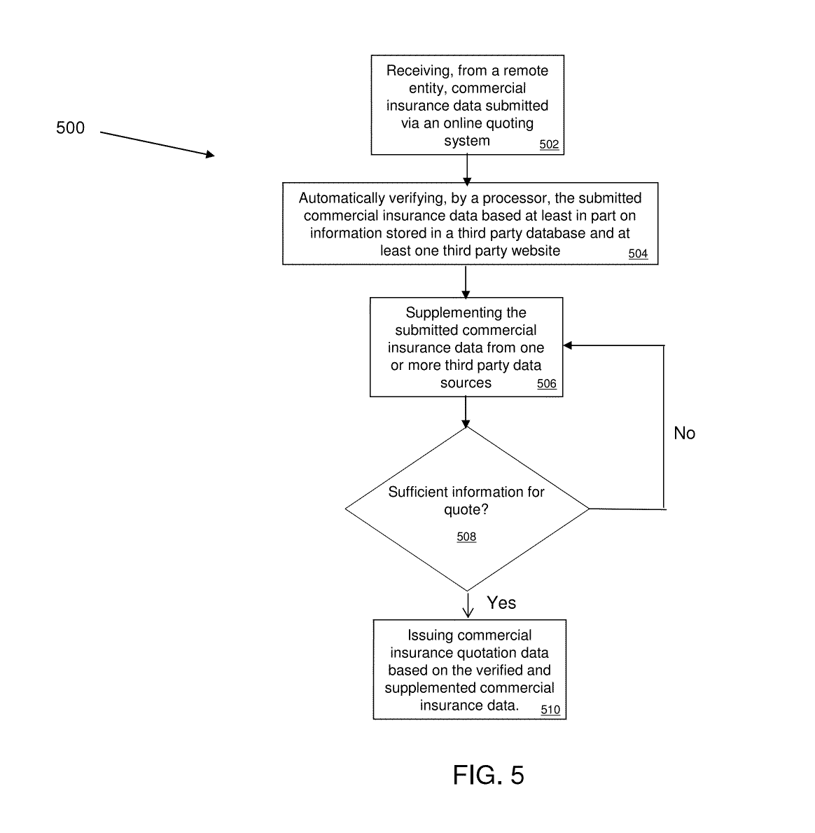

FIG. 5 shows an example process flow diagram illustrating a method 500 for administering an electronic commercial insurance quoting process using the example architecture 100 of FIG. 1. Method 500 includes receiving, from a remote entity, commercial insurance data submitted via an online quoting system, step 502. Method 500 continues with automatically verifying, by a processor, the submitted commercial insurance data based at least in part on information stored in a third party database and at least one third party website, step 504. Method 500 continues with supplementing the submitted commercial insurance data from one or more third party data sources, step 506. It is determined if the supplemented information is sufficient to generate a quote for the requested commercial insurance coverage, step 508. This determination may be performed by comparing the information that was submitted and supplemented with one or more business rules related to the sufficiency of information needed to produce the quote. For example, the business rules may establish that at least the business name and one driver's license number is necessary to produce the quote. Business rules may also be state specific and/or information vendor specific and relate to the requirements of each state and/or information vendor; for example, certain states/vendors may require certain variations in content and format of information requests and transmissions and variations in authentication data. Method 500 continues with issuing commercial insurance quotation data based on the verified and supplemented commercial insurance data, step 510

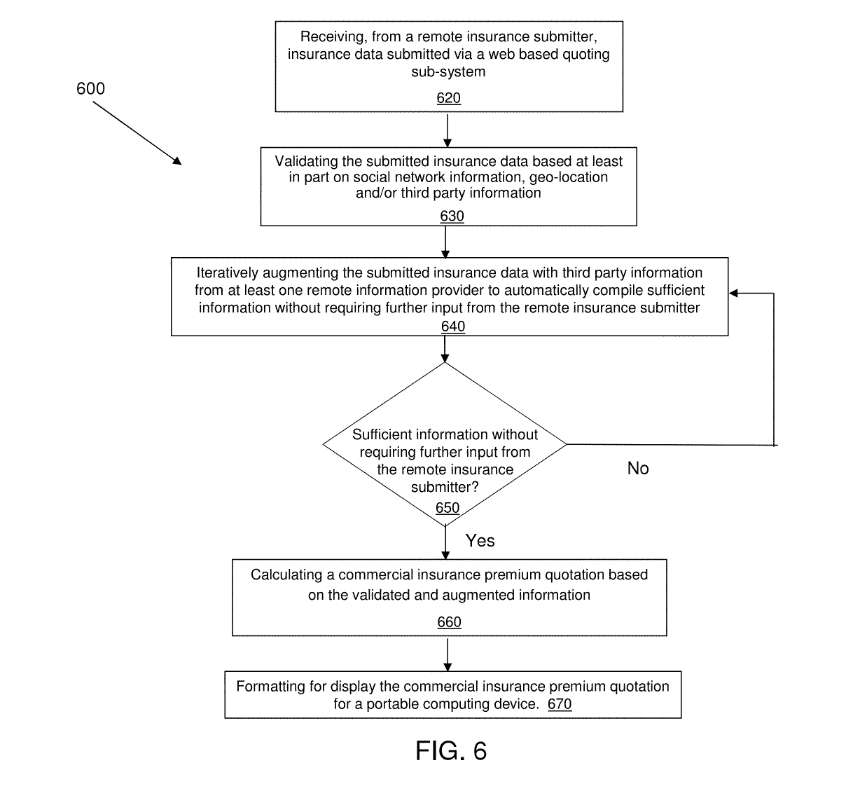

FIG. 6 shows a process flow diagram illustrating another computer implemented method 600 of the present invention. Method 600 begins with receiving, from a remote entity, such as a remote insurance submitter, insurance data submitted via a web based quoting sub-system, step 620. The web based quoting sub-system may display an online quotation submission form with fields into which a user may enter data. The submitter may be, and the remote entity may be associated with, a commercial insurance agent, either affiliated or independent, a commercial insurance agency, a party, such as an employee, entering information on behalf of a commercial insurance agent, or may be a business consumer who is a potential insurance customer in a direct to consumer implementation. By way of example, data received via the remote entity may include user identification or authentication data, cookies or other device data, which data is associated with a submitter. The submitted information is then validated based at least in part on social network information, geo-location information, or third party information step 630. For example, geo-location information may be used to validate the business name such as in the case where multiple similar business names exist so the geo-location information may be used to narrow down the choice of business names to the relevant name being currently quoted. Geo-location information may be from the user's device such as their smart-phone, automobile or tablet computing device. Location data from the user's device may be compared to stored location data of one or more commercial entities to determine the correct business name. In another example, the submitted commercial insurance data may include a commercial driver's license number. Method 600 continues with iteratively augmenting the submitted insurance data with third party information from at least one remote information provider to automatically compile sufficient information without requiring further input from the remote insurance submitter, step 640. For example, iteratively augmenting could start with a business name, that is augmented with driver's license information associated with the business name from a third party source, which is then augmented with additional driver information from a social network, which is then augmented with driver history information from the DMV, etc. By way of further example, augmenting could include augmenting submitted commercial driver's license number data with Vehicle Identification Number (VIN) data associated with the commercial driver's license number from a third party data base, and then augmenting the VIN data with vehicle data from a motor vehicle registration database. The system may cause the online quotation submission form to be displayed pre-filled on the user-display with data accessing from one or more third party data sources, such as motor vehicle records, geo-location data sources, and social networking data sources. The system may be configured to permit the user to interact with a display device to confirm the pre-filled data in the online quotation submission form or to correct the pre-filled data prior to a step of calculating a premium quotation.

Referring still to FIG. 6, it is determined if sufficient information has been collected or compiled without requiring further input from the remote insurance submitter, step 650. Provided sufficient information has been compiled, method 600 proceeds with calculating a commercial insurance premium quotation based on the validated and augmented information, step 660. Method 600 continues with formatting for display the commercial insurance premium quotation for a portable computing device, step 670.

One or more steps of method 600 may be implemented as computer program instructions provided on a non-transitory computer-readable medium for execution by one or more processors. As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-ray Disc, or other type of device for electronic data storage.

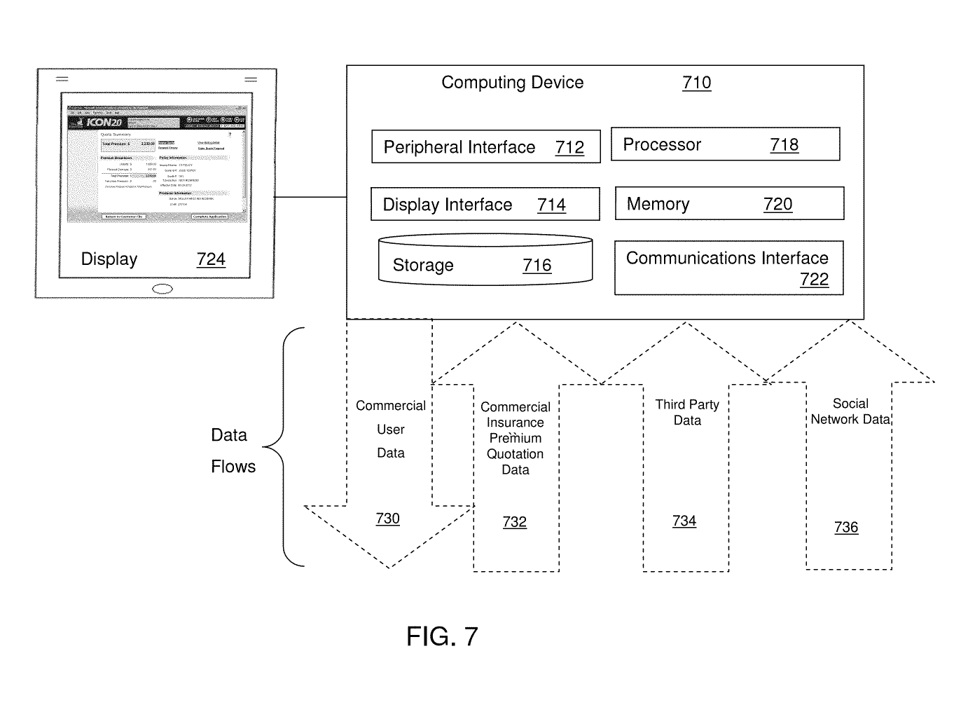

FIG. 7 shows an example computing device 710 that may be used to implement features describe above. The computing device 710 may include a peripheral device interface 712, display device interface 714, a storage device 716, a processor 718, a memory device 720, and a communications interface 722. Computing device 710 may be coupled to a display device 724, which may be separately coupled to or included within the computing device 710. In operation, computing device 710 is configured to receive and transmit a number of data flows via communications interface 722 including, for example, commercial user data 730, commercial insurance premium quotation data 732, third party data 734 social network data 736.

The peripheral device interface 712 may be an interface configured to communicate with one or more peripheral devices. The peripheral device interface 712 may operate using a technology such as Universal Serial Bus (USB), PS/2, Bluetooth, infrared, serial port, parallel port, and/or other appropriate technology. The peripheral device interface 712 may, for example, receive input data from an input device such as a keyboard, a mouse, a trackball, a touch screen, a touch pad, a stylus pad, and/or other device. Alternatively or additionally, the peripheral device interface 712 may communicate output data to a printer that is attached to the computing device 710 via the peripheral device interface 712.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 700.

The memory device 720 of FIG. 7 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

An instance of the computing device 710 of FIG. 7 may be configured to perform any feature or any combination of features described above as performed by the client device 130 as described with respect to FIG. 1. In such an instance, the memory device 720 and/or the storage device 716 may store instructions which, when executed by the processor 718, cause the processor 718 to perform any feature or any combination of features described above as performed by the web browser module 134. Alternatively or additionally, in such an instance, each or any of the features described above as performed by the web browser module 134 may be performed by the processor 718 in conjunction with peripheral device interface 712, display device interface 714, and/or storage device 716, memory device 720, and communication interface 722.

Alternatively or additionally, an instance of the computing device 710 may be configured to perform any feature or any combination of features described above as performed by the commercial insurance data system 110. In such an instance, the memory device 720 and/or the storage device 716 may store instructions which, when executed by the processor 718, cause the processor 718 to perform any feature or any combination of features described above as performed by the interface module 112 and/or the insurance quote calculation module 114. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the product management system 170. In such an instance, the memory device 720 and/or the storage device 716 may store instructions which, when executed by the processor 718, cause the processor 718 to perform any feature or any combination of features described above as performed by product management system 170. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the web site system 120. In such an instance, the memory device 720 and/or the storage device 716 may store instructions which, when executed by the processor 718, cause the processor 718 to perform any feature or any combination of features described above as performed by the insurance web application module 122 and/or the HTTP server module 124. In such an instance, the processor 718 may perform the feature or combination of features in conjunction with the memory device 720, communication interface 722, peripheral device interface 712, display device interface 714, and/or storage device 716.

Although FIG. 7 shows that the computing device 710 includes a single processor 718, single memory device 720, single communication interface 722, single peripheral device interface 712, single display device interface 714, and single storage device 716, the computing device may include multiples of each or any combination of these components 712, 714, 716, 718, 720, and 722 and may be configured to perform analogous functionality to that described above.

Although the methods and features described above with reference to FIGS. 1-7 are described above as performed using the example architecture 100 of FIG. 1 and the example system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described with reference to FIGS. 1-7 may be used alone without the other features and elements or in various combinations with or without other features and elements. Sub-elements of the methods and features described above with reference to FIGS. 1-7 may be performed in any arbitrary order (including concurrently), in any combination or sub-combination.

What is claimed is:

1. A commercial automobile insurance quoting system, comprising:
a data storage device storing data associated with a commercial automobile information database;
a computer processor for executing program instructions and configured to retrieve said data associated with the commercial automobile information database from the data storage device; and
a memory, coupled to the computer processor, storing program instructions, which, when executed by the computer processor, cause the computer processor to:
receive, from a remote entity, complete or partial commercial business data submitted via an electronic quoting system in connection with business and driver data associated with a commercial entity;
automatically validate the submitted commercial business data based at least in part on information accessed from at least two or more of a municipal data source, a commercial information service, a social network and a location based data source;
iteratively augmenting the validated insurance data from at least two of the municipal data source, the commercial information service, the social network and the location based data source to automatically compile sufficient insurance data to determine a commercial automobile insurance quotation for the commercial entity;
determine a bindable commercial automobile insurance quotation for the commercial entity based on the validated and augmented data and information from a product management system;
and
transmit the commercial automobile insurance quotation for display in the electronic quoting system.

2. The system of claim 1, wherein the submitted commercial automobile insurance data comprises a commercial entity name and address.

3. The system of claim 1, wherein the submitted commercial automobile insurance data comprises basic driver information.

4. The system of claim 3, wherein the program instructions further cause the processor to augment the basic driver information via the third party data source.

5. The system of claim 1, wherein the remote entity is associated with at least one of: (i) an insurance agent, (ii) an insurance agency, (iii) a party entering information on behalf of an insurance agent, or (iv) a potential insurance customer.

6. The system of claim 1, wherein the submitted insurance data is associated with a state and a driver's license number.

7. The system of claim 6, wherein at least Vehicle Identification Number (VIN) information is automatically pre-filled from the third party data source.

8. The system of claim 1, wherein augmenting the submitted insurance data with third party information from at least one remote information provider comprises driver information for a plurality of unrelated drivers.

9. The system of claim 1, wherein the program instructions further cause the processor to validate the location of the commercial entity using the location based information.

10. The system of claim 9, wherein the program instructions further cause the processor to compare the location of the commercial entity to the location of the remote entity.

11. The system of claim 1, wherein intelligently augmenting the validated insurance data from one or more third party data sources comprises accessing motor vehicle records and pre-filling an online quotation submission form.

12. The system of claim 1, wherein the memory includes business rules stored thereon related to state and vendor requirements.

13. The system of claim 1, wherein the social network is a professional networking website.

14. A computer-implemented method associated with a commercial automobile insurance quoting process, comprising:
receiving, from a remote entity, commercial insurance data submitted via an online quoting system;
automatically verifying, by a processor, the submitted commercial insurance data based at least in part on information stored in a third party database and at least one third party website;
supplementing the submitted commercial insurance data from one or more third party data sources;
and
issuing commercial insurance quotation data based on the verified and supplemented commercial insurance data.

15. The method of claim 14, wherein the remote entity is associated with at least one of: (i) an insurance agent, (ii) an insurance agency, or (iii) a potential commercial insurance customer.

16. The system of claim 15, wherein the submitted commercial insurance data is associated with a commercial driver's license number and the commercial driver's license number is augmented with Vehicle Identification Number (VIN) information.

17. The system of claim 14, wherein supplementing the submitted commercial insurance data from one or more third party data sources comprises accessing at least one global positioning based information source.

18. A non-transitory computer-readable medium storing instructions adapted to be executed by a computer processor to perform a commercial insurance based method, said method comprising:
receiving, from a remote insurance submitter, insurance data submitted via a web based quoting sub-system;
validating the submitted insurance data based at least in part on social network information and geo-location information;
iteratively augmenting the submitted insurance data with third party information from at least one remote information provider to automatically compile sufficient information for calculation of a commercial insurance premium quotation without requiring further input from the remote insurance submitter;
calculating a commercial insurance premium quotation based on the validated and augmented information; and
formatting for display the commercial insurance premium quotation for a portable computing device.

19. The non-transitory computer-readable medium of claim 18, wherein augmenting the submitted insurance data with third party information from at least one remote information provider comprises accessing Vehicle Identification Information (VIN) and driver information.

20. The non-transitory computer-readable medium of claim 18, wherein validating the submitted insurance data based at least in part on social network information and geo-location information comprises accessing a professional networking website to access commercial business information.
